(19) United States
(12) Patent Application Publication
(10) Pub. No.: US 2019/0165338 A1
(43) Pub. Date: May 30, 2019

(54) BENDABLE BATTERY

(71) Applicants: Fu Tai Hua Industry (Shenzhen) Co., Ltd., Shenzhen (CN); HON HAI PRECISION INDUSTRY CO., LTD., New Taipei (TW)

(72) Inventors: HUA-HU ZENG, Shenzhen (CN); HSU-MIN KUO, New Taipei (TW)

(21) Appl. No.: 15/869,040

(22) Filed: Jan. 12, 2018

(30) Foreign Application Priority Data
Nov. 24, 2017 (CN) 201721599252.6

(51) Int. Cl. H01M 2/02; H01M 4/505; H01M 4/131; H01M 4/133

(52) U.S. Cl. CPC H01M 2/0275; H01M 4/505; H01M 2004/028; H01M 4/133; H01M 4/131

(57) ABSTRACT

A battery includes a housing which is bendable. The housing includes a number of cells spaced apart from each other within the housing. The housing further includes a current collecting unit arranged within the housing and configured to electrically couple the number of cells together.

### CROSS-REFERENCE TO RELATED APPLICATIONS

This application claims priority to Chinese Patent Application No. 201721599252.6 filed on Nov. 24, 2017, the contents of which are incorporated by reference herein.

### FIELD

The subject matter herein generally relates to batteries, and more particularly to a bendable battery for wearable electronic devices.

### BACKGROUND

FIG. 1 shows a battery 200 of a wearable electronic device such as a smart watch. The battery 200 includes a positive terminal 62, a negative terminal 64, and a separating film 66 layered and rolled together and received within a housing 70. However, the wearable electronic device must conform to the shape of the user, and if the electronic device must be bent to conform to the user, the battery 200 may also be bent, which may cause the positive terminal 62 or the negative terminal 64 to penetrate the separating film 66 and cause fire.

### BRIEF DESCRIPTION OF THE DRAWINGS

Implementations of the present disclosure will now be described, by way of example only, with reference to the attached figures.

FIG. 1 is a battery of the prior art.

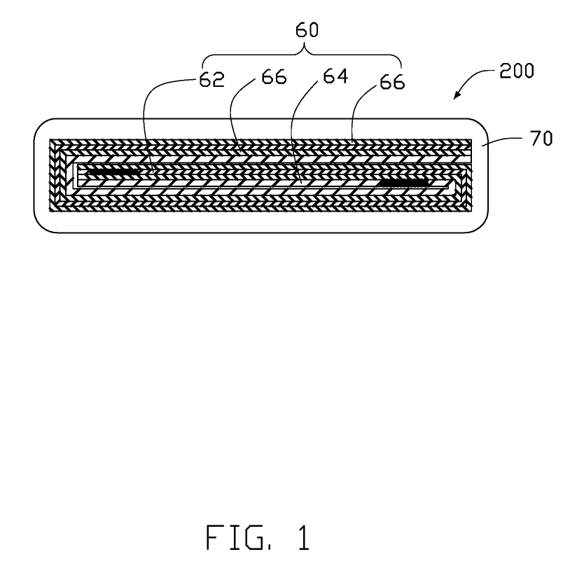

FIG. 2 is an assembled, side view of an exemplary embodiment of a battery in accordance with an embodiment of the present disclosure.

FIG. 3 is an electric diagram of the battery in FIG. 2.

FIG. 4 is a side view of the battery of FIG. 2 in a bent state.

FIG. 5 is a side view of another embodiment of the battery.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

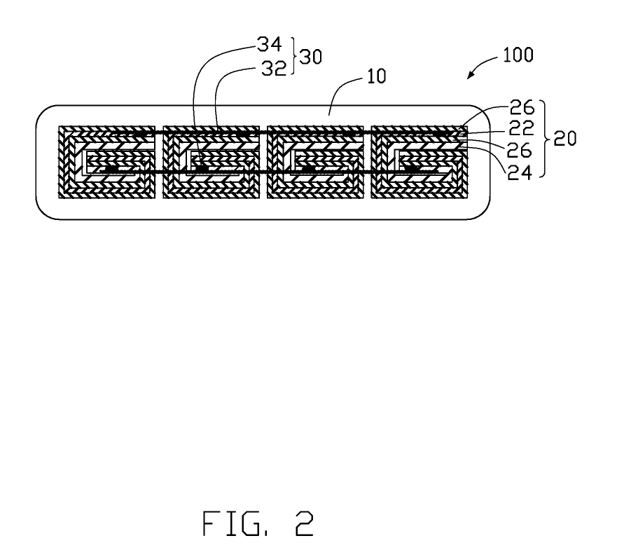

FIG. 2 illustrates an embodiment of a battery 100. The battery 100 may be used in a smart watch, electronic bracelet, or other wearable electronic device. The battery 100 is bendable.

The battery 100 includes a housing 10, a plurality of cells 20, and a current collecting unit 30.

The housing 10 is bendable to bend along with the battery 100. The housing 10 houses the plurality of cells 20 and the current collecting unit 30.

The plurality of cells 20 are spaced apart in a row within the housing 10. Correspondingly, the housing 10 is bendable along an arrangement direction of the plurality of cells 20 and cannot bend along an axial direction of the cells 20.

In at least one embodiment, each cell 20 includes a positive electrode sheet 22, a negative electrode sheet 24, and a separating film 26. The positive electrode sheet 22 is an aluminum foil coated with lithium cobalt oxide or manganese lithium copolymer. The negative electrode sheet 24 is a copper foil coated with graphite. The separating film 26 is a selective membrane. For example, the separating film 26 may selectively allow lithium ions to pass through and not electrons. A thickness of the separating film 26 is about 15 micrometers.

In at least one embodiment, the positive electrode sheet 22, the negative electrode sheet 24, and the separating film 26 are substantially rectangular. Each cell 22 is formed by rolling the positive electrode sheet 22, the negative electrode sheet 24, and the separating film 26 together. The separating film 26 separates the positive electrode sheet 22 from the negative electrode sheet 24 to electrically isolate the positive electrode sheet 22 from the negative electrode sheet 24. In at least one embodiment, a process of forming the cell 20 includes layering the positive electrode sheet 22, the separating film 26, the negative electrode sheet 24, and another separating film 26 in sequence, and then rolling to form the cell 20, such that the separating film 26 is always between the positive electrode sheet 22 and the negative electrode sheet 24. A quantity of rolls of the cell 20 depends on a power requirement of the battery 100. As the quantity of rolls increases, the power of the battery 100 increases, and a size of the cell 20 increases.

The plurality of cells 200 are electrically coupled together and output electric charge through the current collecting unit 30. The cells 20 can be electrically coupled in series, in parallel, or a combination of in series and in parallel according to power requirements of the battery 100. In general, series coupling increases voltage, and parallel coupling increases current.

The current collecting unit 30 includes a positive current collecting plate 32 and a negative current collecting plate 34. The positive current collecting plate 32 and the negative current collecting plate 34 are a bendable electrically conductive plate and are arranged at an end of the cell 20. The positive current collecting plate 32 is used for electrically coupling some or all of the positive electrode sheets 22 together. The negative current collecting plate 34 is used for electrically coupling some or all of the negative electrode sheets 24 together. In at least one embodiment, the plurality of cells 20 are electrically coupled together through the current collecting unit 30 in parallel, the positive current collecting plate 32 electrically couples all of the positive electrode sheets 22 together, and the negative current collecting plate 34 electrically couples all of the negative electrode sheets 24 together.

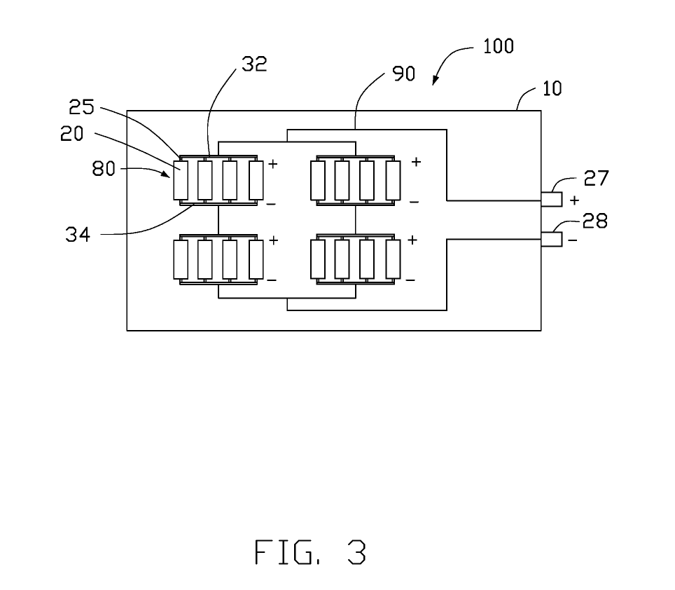

Referring to FIG. 3, in another embodiment, the positive electrode sheet 22 and the negative electrode sheet 24 each include a lead 25. The lead 25 extends from the corresponding end of the cell 20 and is electrically coupled to the positive current collecting plate 32 or the negative current collecting plate 34. The battery 100 further includes a positive output terminal 27, a negative output terminal 28, at least one cell pack 80, and a wire 90. The positive output terminal 27 and the negative output terminal 28 are arranged on a side of the housing 10 for outputting electric charge of the battery 100. The cell pack 80 includes the plurality of cells 20. The cells 20 are electrically coupled in parallel through the positive current collecting plate 32 and the negative current collecting plate 34 to make up the cell pack 80. The wire 90 electrically coupled to the positive current collecting plate 32 and the negative current collecting plate 34 electrically couples the at least one cell pack 80 together in series or in parallel, and then outputs electric charge through the positive output terminal 27 or the negative output terminal 28.

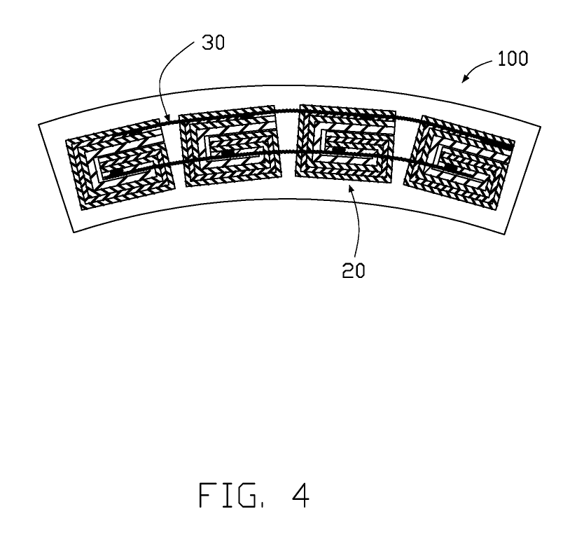

Referring to FIG. 4, in use, when the battery 100 is bent by an outside force, the housing 10 is also bent. Since the cells 20 are arranged spaced apart, the cells 20 can move within the space between adjacent cells 20 along with the housing 10. Thus, the cells 20 themselves are not bent, the cells 20 do not penetrate the separating film 26, and the cells 20 are prevented from catching fire.

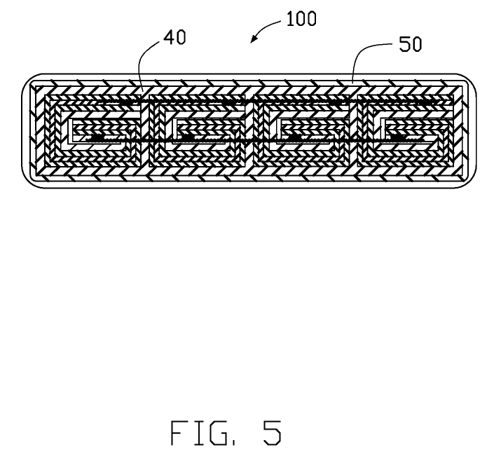

Referring to FIG. 5, the battery 100 further includes a supporting structure 40 made up of a plurality of hollow tubular structures arranged in a row for separating and positioning the plurality of cells 20. Each cell 20 is received in a corresponding hollow tubular structure to prevent the cells 20 from shifting. The cells 20 and the supporting structure 40 are received within the housing 10. An outer surface of the supporting structure 40 abuts the housing 10. The supporting structure 40 is made of soft insulating material, such as foam or a film. Thus, the supporting structure 40 can separate and position the cells 20 while bending along with the housing 10 without damaging the cells 20.

In another embodiment, the battery 100 further includes a wrapping film 50 for wrapping the plurality of cells 20, the current collecting unit 30, and the supporting structure 40 together within the housing 10. The wrapping film 10 includes three layers. A first layer most adjacent to the cell 20 is made of polypropylene for creating a seal during hot-pressing. A second layer of the wrapping film 40 is made of aluminum for keeping out air. A third layer furthest away from the cell 20 is made of nylon for waterproofing.

The battery 100 utilizes the plurality of cells 20 instead of one big cell, so that the battery 100 can bend without affecting the cells 20.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A battery comprising:
a housing which is bendable;
a plurality of cells arranged within the housing and spaced apart from each other; and
a current collecting unit arranged within the housing and configured to electrically couple the plurality of cells together.

2. The battery of claim 1, wherein the plurality of cells are arranged in a single row, and the housing is bendable along an arrangement direction of the plurality of cells.

3. The battery of claim 1, wherein each of the plurality of cells comprises a positive electrode sheet, a negative electrode sheet, and a separating film; the separating film is between the positive electrode sheet and the negative electrode sheet; the positive electrode sheet, the negative electrode sheet, and the separating film are rolled together to form the cell.

4. The battery of claim 3, wherein the current collecting unit comprises a positive current collecting plate and a negative current collecting plate; the positive current collecting plate and the negative current collecting plate are arranged at an end of the cell; the positive current collecting plate is configured to electrically couple some or all of the positive electrode sheets; the negative current collecting plate is configured to electrically couple some or all of the negative electrode sheets.

5. The battery of claim 4, further comprising a supporting structure made up of a plurality of hollow tubular structures arranged in a row for separating and positioning the plurality of cells; wherein each cell is received in a corresponding hollow tubular structure.

6. The battery of claim 5, further comprising a wrapping film for wrapping around the plurality of cells, the current collecting unit, and the supporting structure received within the housing.

7. The battery of claim 6, wherein the positive electrode sheet is an aluminum foil coated with lithium cobalt oxide or manganese lithium copolymer; the negative electrode sheet is a copper foil coated with graphite; the separating film is a selective membrane.

8. The battery of claim 7, wherein the wrapping film comprises a first layer, a second layer, and a third layer; the first layer most adjacent to the cell is made of polypropylene for creating a seal during hot-pressing; the second layer is made of aluminum for keeping out air; the third layer furthest away from the cell is made of nylon for waterproofing.

9. The battery of claim 4, further comprising a wire, a positive output terminal, and a negative output terminal; wherein an end of the positive electrode sheet and an end of the negative electrode sheet have arranged thereon a lead; the lead is electrically coupled to the positive electrode sheet or the negative electrode sheet; the lead outputs electric charge through the positive output terminal and the negative output terminal after electrically coupling the positive electrode sheets and the negative electrode sheets in parallel or in series.

10. The battery of claim 8, wherein the housing, the current collecting unit, and the supporting structure are bendable.
